(19) United States
(12) Patent Application Publication
(10) Pub. No.: US 2015/0196443 A1
(43) Pub. Date: Jul. 16, 2015

(54) Adjustable Bed Controller

(71) Applicant: Peter Tarquinio, Pomona, CA (US)

(72) Inventor: Peter Tarquinio, Pomona, CA (US)

(21) Appl. No.: 14/152,642

(22) Filed: Jan. 10, 2014

(51) Int. Cl. A61G 7/018; F21V 33/00

(52) U.S. Cl. CPC A61G 7/018; F21V 33/0012; F21W 2131/301

(57) ABSTRACT

An adjustable bed controller is attached to a flexible conduit that has one end attached to a bed frame. An optional lamp may be attached to the other end of the conduit. The adjustable bed controller has buttons that may be pressed to adjust the various parts of the bed frame and to control the lamp.

### BACKGROUND OF THE INVENTION

1. Field of the Invention

This invention relates generally to position control systems for adjustable beds and particularly to a position control system that is attached to the frame of an adjustable bed.

2. Description of the Prior Art

Prior art adjustable bed position controllers typically are hand-held devices that, when not in use, are often placed on tables, under pillows or on or under the bed covers. Such devices are subject to being misplaced or being inconvenient to locate or reach.

### SUMMARY OF THE INVENTION

An adjustable bed controller according to the present invention is attached to a flexible conduit that has one end attached to a bed frame. An optional lamp may be attached to the other end of the conduit. The adjustable bed controller has buttons that may be pressed to adjust the various parts of the bed frame and to control the lamp.

An adjustable bed position controller configured for mounting to an adjustable bed frame comprises a base formed for attachment to a selected location on the adjustable bed frame; a conduit having a first end connected to the base such that the conduit extends outwardly from the base; and a control unit attached to the conduit. The control unit preferably includes switches configured for manual actuation to provide position control signals to place the bed frame in a selected position. The conduit preferably is flexible such that the control unit may be placed in a desired location relative to the adjustable bed frame, and the conduit further preferably has a memory such that the conduit retains the control unit in the desired location until a person moves the control unit to another location.

The control unit may receive operating power from a battery or from electrically conducting wires extending from the control unit through the conduit for connection to an electric outlet.

The adjustable bed position controller according to the present invention may include an electric lamp is connected to a second end of the conduit and the control unit includes switches for controlling the lamp.

### BRIEF DESCRIPTION OF THE DRAWINGS

FIG. 1 is a side elevation view showing an adjustable bed controller according to the present invention attached to an adjustable bed frame; and

FIG. 2 illustrates a mounting plate that may be used to mount the adjustable bed controller of FIG. 1 to the adjustable bed frame.

### DETAILED DESCRIPTION OF THE INVENTION

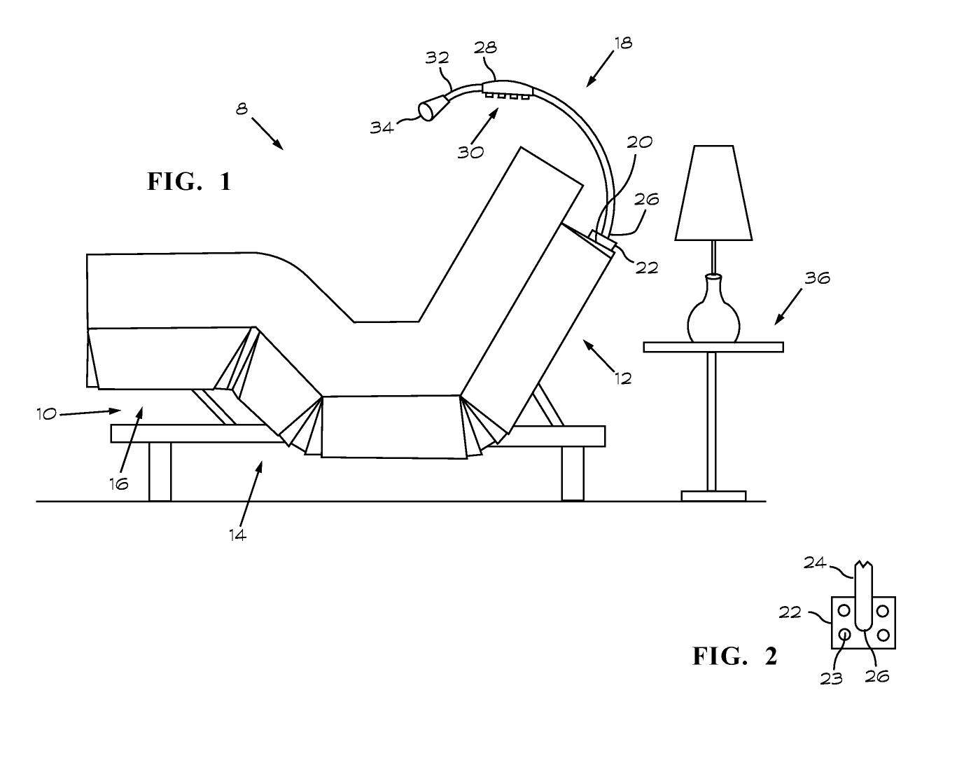

Referring to FIG. 1, a bed 8 includes an adjustable bed frame 10. The adjustable bed frame 10 is shown with its upper body section 12 and leg support sections 14 and 16 elevated. An adjustable bed position control system 18 is mounted to a head portion 20 of the adjustable bed frame 10.

The adjustable bed position control system 18 includes a base 22 that is fastened to the adjustable bed frame 10. FIG. 2 illustrates an example of a technique for fastening the base 22 to the head portion 20. FIGS. 1 and 2 show the base 22 as a plate having four holes 23 suitable for receiving screws or bolts that may be used to fasten the base securely to the frame 10. Other mounting means such as clamps, magnets, adhesives, etc. may alternatively be used to fasten the base 22 to the frame 12.

The adjustable bed position control system adjustable bed position control system also includes a conduit 24 having an end 26 that extends outwardly from the base 22. A control unit 28 is mounted to the conduit 24. The conduit 24 has flexibility sufficient to permit a person to manually adjust its configuration to place the control unit 28 in a desired location that is convenient for a person lying in the bed 8 to reach the control unit 28. The conduit 24 also has a memory such that the control unit remains in the desired location until a person moves it.

The control unit 28 has buttons or toggle switches 30 that may be manually actuated to control the position of the sections 12, 14 and 16 of the adjustable bed frame 10. The control unit 28 may be formed in a conventional manner to provide radio signals to conventional actuators (not shown) connected to the adjustable bed frame 10. Alternatively, the switches 30 may be hard-wired to the actuators.

The control unit 28 may receive electrical power either from a battery or from electrical wiring that extends through the conduit 24 to an electrical outlet.

As shown in FIG. 1, the conduit 24 may have a section 32 that extends beyond the control unit 28 to support a lamp 34.

The flexibility of the conduit permits a user to adjust the lamp's position so that light from the lamp 34 will not disturb another person in the bed. In an arrangement having two parallel adjustable bed frames, each frame can have its own adjustable bed position control system adjustable bed position control system, which is convenient when two people in the bed do activities such as reading.

Another advantage provided by the present invention is that the control unit 28 may always be within reach and cannot get lost in the bed or fall on the floor. As shown in FIG. 1, a bedside table 36 is not a convenient storage location for the control unit 28 because when the frame 10 is raised, the table 36 is behind the bed 8 and may be out of reach.

What is claimed is:

1. An adjustable bed position controller configured for mounting to an adjustable bed frame, comprising:
a base formed for attachment to a selected location on the adjustable bed frame;
a conduit having a first end connected to the base such that the conduit extends outwardly from the base; and
a control unit attached to the conduit, the control unit having switches configured for manual actuation to provide position control signals to place the bed frame in a selected position, the conduit having a flexibility such that the control unit may be placed in a desired location relative to the adjustable bed frame, and the conduit further having a memory such that the conduit retains the control unit in the desired location until a person moves the control unit to another location.

2. The adjustable bed position controller of claim 1 wherein the control unit receives operating power from a battery.

3. The adjustable bed position controller of claim 1 wherein the control unit receives operating power from wires extending from the control unit through the conduit for connection to an electric outlet.

4. The adjustable bed position controller of claim 1 wherein an electric lamp is connected to a second end of the conduit and the control unit includes switches for controlling the lamp.
